(19) United States
(12) Patent Application Publication
(10) Pub. No.: US 2004/0202803 A1
(43) Pub. Date: Oct. 14, 2004

(54) Spandrel panel with low visible light transmittance pane

(75) Inventor: Scott E. Hoover, Atlanta, GA (US)

Correspondence Address: MARSHALL & MELHORN, LLC, 8TH FLOOR, FOUR SEAGATE, TOLEDO, OH, 43604, US

(73) Assignee: Pilkington North America, Inc.

(21) Appl. No.: 10/413,178

(22) Filed: Apr. 14, 2003

(51) Int. Cl. E06B 3/24

(52) U.S. Cl. 428/34

(57) ABSTRACT

A spandrel panel is provided which has at least one low visible light transmittance pane having a composition such that the low visible light transmittance pane exhibits, when measured utilizing Illuminant D65, a visible light transmittance (Tᵥᵢₛ) of 15% or less. In the past, spandrel panels were typically constructed with a film or coating, for example a frit, disposed on at least one surface of one of the panes or with a sheet of opaque material positioned within or next to the spandrel panel. In the present invention, obtaining low visible light transmittance through the spandrel panel is achieved via the chemical composition of at least one of the panes. This results in a lower cost spandrel panel.

### BACKGROUND OF THE INVENTION

The present invention relates to a glass panel and more particularly to a glass spandrel panel for use in glazing the exterior of a building, in areas other than vision areas.

Spandrels are employed, for the most part, to conceal interior portions of a building that would not necessarily be aesthetically pleasing if viewed from the exterior of the building. Examples of such interior portions would be building frame members, heating and air conditioning ducts, tubing or plumbing, and electrical bundles or conduits. In addition to the purpose of concealing interior portions of the building, a spandrel panel will, typically, aesthetically complement or harmonize with: A) the vision area panels of the building that are used to glaze the vision areas of the building, and B) other attributes of the building's facade.

Various types of vision area and spandrel panels are known in the art. Such panels include insulated glass (IG) panels that have an exterior outboard glass pane that is substantially transparent and a spaced apart inboard glass pane, where the outboard and inboard panes are disposed on a building frame member with a spacer seal disposed therebetween.

The vision area panels may appear to be, for example, transparent, semitransparent, or reflective. They may be green, blue, blue-green, bronze, grey, or various other colors. The spandrel panels may visually appear to be, for example, opaque or reflective. In addition, the spandrel panels may be green, blue, blue-green, bronze, grey, or various other colors. The spandrel panels may also be: 1) thermally insulating, 2) solar energy absorbing and/or reflective, 3) photocatalytic (self cleaning), and/or 4) photovoltaic (generating electricity).

To obtain these properties, it is common to dispose films, coatings, and like materials on the major surfaces of the various panes of the panels. In the past, substantially opaque spandrel panels have been achieved by varying means, for example: a) depositing a film, coating (e.g., frit), or other like materials on various surfaces of the spandrel pane(s), and b) placing a sheet of substantially opaque material within or just outside of the spandrel panel. See U.S. Pat. No. 4,302,503 to Mattimoe that is incorporated herein by reference.

However, these means add materials and labor, and consequently add to the production, transportation, and installation costs of the spandrel panels. Also, current spandrel panels may not complement or harmonize with the vision area panels due to the varying means by which the spandrel effect is achieved.

When a coating, for example a frit, is applied to a glass pane: i) solvents may be required by the process, ii) the frit can deteriorate over the life of the panel, and iii) the coating can be applied unevenly, thus causing a streaked and mottled appearance.

Thus, those skilled in the art continued to seek a solution to the problem of how to provide more aesthetically pleasing and lower cost spandrel panels.

### SUMMARY OF THE INVENTION

The present invention provides spandrel panels that include at least one low visible light transmittance pane, defined herein as a pane having a composition such that the overall visible light transmittance (Tᵥᵢₛ) of the pane is 15% or less. Instead of depositing a film, coating, or like materials on or near at least one surface of an inboard pane, as has been done in the past, the chemical composition of the present invention's spandrel pane (preferably the inboard pane) is chosen to provide the low visible light transmittance. An example of such a pane is a sheet of Super Grey™ glass that is commercially available from Pilkington North America, Inc. of Toledo, Ohio.

Further objects and advantages of the present invention will be apparent from the following description and appended claims, reference being made to the accompanying drawings forming a part of a specification, wherein like reference characters designate corresponding parts of several views.

### BRIEF DESCRIPTION OF THE DRAWINGS

FIG. 1 is a cross-sectional view of an insulated glass spandrel panel in accordance with the present invention.

### DETAILED DESCRIPTION OF THE PREFERRED EMBODIMENTS

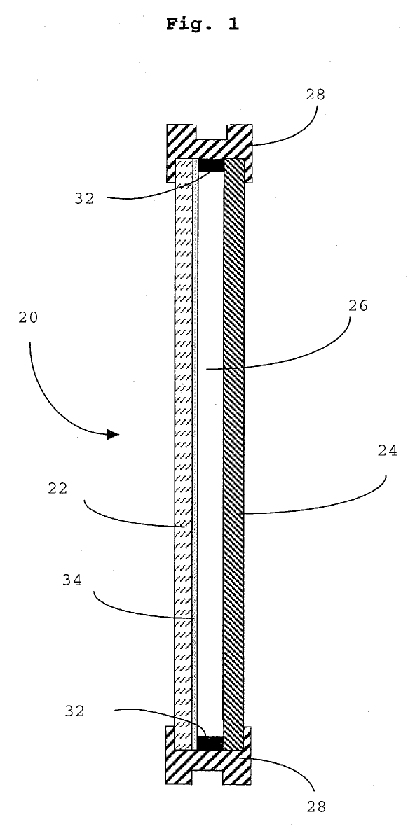

Referring to FIG. 1, there is illustrated a cross-sectional view of a spandrel panel in accordance with the present invention, generally indicated by the numeral 20. As shown, the spandrel panel 20 is embodied as an insulated glass (IG) panel (although other panel constructions are possible) including a substantially transparent outboard pane 22 that typically could be tinted, and a low visible light transmittance inboard pane 24. Coatings 34, for example, solar energy absorbing and/or reflective, photocatalytic, and/or photovoltaic, may be deposited on major surfaces of the panes 22, 24. The inboard 22 and outboard 24 panes are secured and separated by a space or other composition 26 and parallel to one another.

Typically, light that is exterior to a building upon which the spandrel panel 20 is attached radiates onto the outboard transparent pane 22. A portion of the light is then transmitted through the transparent pane 22, the coating 34 (if present), the space 26, and onto the low visible light transmittance pane 24, which has a Tᵥᵢₛ of 15% or less, utilizing the Illuminant D65 visible light standard.

Consequently, the low visible light transmittance pane 24 blocks the exterior light from transmitting through the spandrel 20, so as not to illuminate interior portions within the building and, therefore, not allow those interior building portions to be seen from the exterior of the building.

The spandrel panel 20 may also include a frame member 28, upon which the panes are peripherally disposed, and a separator seal disposed therebetween the panes on the frame member 28.

The substantially transparent reflective pane 22 is produced by disposing a film or coating 34 on a major surface of the pane. A body tinted pane is produced by including colorants into the chemical composition of the pane. The colorants impart a color that is visible to the human eye. For example, including cobalt as a colorant in the chemical composition of Arctic Blue™ glass, that is commercially available from Pilkington North America, Inc. of Toledo, Ohio, imparts the color blue. Examples of other available tinted panes are green, blue-green, grey, and bronze.

Although the present invention is not limited by any coating placed on any of the major surfaces of any of the panes that comprise the panel, the spandrel panel preferably includes a reflective solar control coating 34 on at least one of the major surfaces of the outboard pane 22. The outboard pane may also include other thin film coatings, as its application may require.

In the present invention, the low visible light transmittance of the spandrel panel 20 is achieved without adding materials or labor costs to the spandrel panel, for example, a separate substantially opaque sheet of material within or just outside of the spandrel panel.

In addition, the present invention: 1) realizes lower production, transportation, and installation costs, 2) does not require solvents to apply a substantially opaque coating to at least one surface of a pane of the spandrel panel, 3) has no spandrel coating to peel off over the life of the inboard spandrel pane as with some applied coatings, 4) allows the low visible light transmittance to be evenly distributed throughout all of the spandrel panels, thus preventing a streaked and/or mottled appearance, 5) has good color matching with the appearance of the vision area panels, 6) has good solar control, and 7) may have good low emissivity properties imparted by films that may be applied to the spandrel panels.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

What is claimed is:

1. A spandrel panel, comprising at least one low visible light transmittance pane having a composition such that the low visible light transmittance pane exhibits visible light transmittance of 15% or less.

2. The spandrel panel of claim 1, further comprising at least one additional pane that is secured in a parallel arrangement with the low visible light transmittance pane.

3. The spandrel panel of claim 2, wherein the additional pane is the outboard pane and the low visible light transmittance pane is the inboard pane.

4. The spandrel panel of claim 3, wherein the outboard pane is substantially transparent.

5. The spandrel panel of claim 3, wherein the outboard pane has a visible reflected and transmitted color.

6. The spandrel panel of claim 5, wherein the colored outboard pane has a coating disposed on a major surface thereof.

7. The spandrel panel of claim 6, wherein the coating comprises a solar control coating.

8. The spandrel panel of claim 7, wherein the solar control coating comprises a solar energy absorbing or reflective control coating.

9. The spandrel panel of claim 8, further comprising a frame member that is disposed on a periphery of the panes and having a separator seal disposed between the panes on the frame, wherein the panes are spaced apart.

10. The spandrel panel of claim 9, wherein the low visible light transmittance pane comprises gray tinted glass.

11. A spandrel panel for concealing interior portions of a building, comprising:
at least one body tinted pane that includes a solar energy absorbing or reflective control coating disposed on a major surface;
at least one low visible light transmittance pane having a composition such that the low visible light transmittance pane exhibits, when measured utilizing Illuminant D65, a visible light transmittance of 15% or less, secured in a parallel and spaced apart arrangement with the body tinted pane; and
a frame member that is disposed on a periphery of the panes and having a separator seal disposed between the panes on the frame.

12. A method for producing a spandrel insulated glass panel, comprising:
placing at least one substantially transparent pane in a spaced apart and parallel arrangement with at least one low visible light transmittance pane having a composition such that the low visible light transmittance pane exhibits, when measured utilizing Illuminant D65, a visible light transmittance of 15% or less;
disposing a frame member on the periphery of the panes; and
disposing a separator seal between the panes on the frame member.
